(19) United States
(12) Patent Application Publication
(10) Pub. No.: US 2016/0324202 A1
(43) Pub. Date: Nov. 10, 2016

(54) FOODSTUFF AND AGENT SUBSTANCE INTEGRATION SYSTEM AND METHOD

(71) Applicant: Linda M. Griego, LaPorte, CO (US)

(72) Inventor: Linda M. Griego, LaPorte, CO (US)

(21) Appl. No.: 15/212,199

(22) Filed: Jul. 16, 2016

Related U.S. Application Data
(63) Continuation-in-part of application No. 13/801,717, filed on Mar. 13, 2013, now abandoned.

(51) Int. Cl. A23L 27/00; A23P 10/40

(52) U.S. Cl. CPC A23L 27/70; A23P 10/40; A23V 2002/00

(57) ABSTRACT

A foodstuff and agent substance integration method and system are provided which may be used to integrate one or more agent substances and one or more foodstuffs together to form an agent permeated foodstuff in which the one or more agent substances and the one or more foodstuffs may not be separated by physical or mechanical methods. In some embodiments, the method may include the steps of: adding a foodstuff and one or more agent substances into an agitation device to form a combination consisting essentially of the foodstuff and agent substances; agitating the combination of the foodstuff and agent substances within the agitation device for a period of time in the absence of any additives; and integrating the foodstuff with the agent substances so that an agent permeated foodstuff is created consisting essentially of the foodstuff and the agent substances.

### CROSS REFERENCE TO RELATED APPLICATIONS

This application is a continuation-in-part of U.S. Non-Provisional application Ser. No. 13/801,717, filed on Mar. 13, 2013, entitled “Methods and Apparatus for the Infusion of Foodstuffs with Agent Substances”, which is hereby incorporated by reference in its entirety.

### FIELD OF THE INVENTION

This patent specification relates to the field of foodstuff preparation. More specifically, this patent specification relates to systems and methods that facilitate the integration of one or more agent substances—such as for flavor, nutrition, medication, or the like—into the structures of dry foodstuffs.

### BACKGROUND

Flavor combination is a well known practice that involves combining two or more foodstuff items to create a new foodstuff that incorporates the flavors of the combined foodstuff items. For example, chocolate covered dried cranberries have a unique flavor that is created by coating a dried cranberry in liquid chocolate and then drying the chocolate. While widely practiced in foodstuff preparation, conventional combining practices may come with a number of drawbacks. For example, conventional combining practices may rely on liquid processes or coating ingredients to accomplish combining, perhaps adding time, expense, and potentially unnecessary ingredients to a combining system. Conventional combining practices also may have failed to produce certain foodstuff and flavor combinations available via a combining system that does not rely on liquid coatings and other coating agents. Unfortunately, these coatings may be easily dislodged from the surface of a coated foodstuff through washing, normal handling, transportation settling, and the like.

The foregoing problems related to conventional foodstuff preparation may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

Therefore, a need exists for novel systems and methods that facilitate the integration of one or more agent substances, such as for flavor, nutrition, medication, or the like, into the structures of dry foodstuffs. There is a further need for novel foodstuff and agent substance integration systems and methods that do not rely on liquid coatings and other coating agents. Finally, there exists a need for novel foodstuff and agent substance integration systems and methods that are able to integrate foodstuff and agent substances together into a product in which the agent substances are not dislodged from the surface of an integrated foodstuff product through washing, normal handling, transportation settling, and the like.

BRIEF SUMMARY OF THE INVENTION

A foodstuff and agent substance integration method and system are provided. The foodstuff and agent substance integration method and system may be used to integrate one or more agent substances and one or more foodstuffs together to form an agent permeated foodstuff in which the one or more agent substances and the one or more foodstuffs may not be separated by physical or mechanical methods. This integration is distinct from a foodstuff that is coated with a cereal or flavoring agent since the coating of the cereal or flavoring agent may be broken off, washed off, or otherwise removed from the foodstuff

In some embodiments a foodstuff and agent substance integration method may include the steps of: adding a foodstuff and one or more agent substances into an agitation device to form a combination consisting essentially of the foodstuff and the one or more agent substances; agitating the combination of the foodstuff and the one or more agent substances within the agitation device for a period of time in the absence of any additives; and integrating the foodstuff with the one or more agent substances so that an agent permeated foodstuff is created consisting essentially of the foodstuff and the one or more agent substances.

In further embodiments, the inventive technology may utilize method for creating a flavor infused foodstuff comprising the steps of providing a substantially dry agent substance, providing a substantially dry foodstuff, agitating said substantially dry agent substance and said substantially dry foodstuff in the substantial absence of a liquid which is not intrinsic to the said substantially dry agent substance and said substantially dry foodstuff, permeating said substantially dry foodstuff with said substantially dry agent substance as a result of said step of agitating, and creating an agent permeated foodstuff from said substantially dry agent substance and said substantially dry foodstuff.

In another embodiment, the inventive technology may utilize an agitation device having a substantially dry agent substance input, a substantially dry foodstuff input, a substantially liquid-free agitation area configured to receive said substantially dry agent substance from said substantially dry agent substance input and said substantially dry foodstuff from said substantially dry foodstuff input, a substantially liquid-free permeation zone of said substantially liquid-free agitation area responsive to said substantially dry agent substance input and said substantially dry foodstuff input, and a agent permeated foodstuff output responsive to said substantially dry agitation area.

In another embodiment, the inventive technology may utilize a method for flavoring a foodstuff including the steps of providing a coffee flavor agent substance, providing a raisin foodstuff, permeating at least some of said raisin with said coffee flavor agent substance, and infusing at least some of said raisin with said coffee flavor agent substance as a result of said step of permeating, and creating a coffee flavor agent permeated raisin from said coffee flavor agent substance and said raisin.

In another embodiment, the inventive technology may utilize a flavored foodstuff having a raisin having a permeable structure, a coffee flavor agent substance infused into at least some of said permeable structure of said raisin, and a coffee flavor of said raisin.

Naturally, further objects of the inventive technology will become apparent from the description and drawings below.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of an example of a foodstuff and agent substance integration system according to various embodiments described herein.

FIG. 2—FIG. 2 illustrates a sectional, through sectional plane A shown in FIG. 1, elevation view of an example of a foodstuff and agent substance integration system according to various embodiments described herein.

FIG. 3—FIG. 3 shows a sectional, through sectional plane A shown in FIG. 1, elevation view of a further example of a foodstuff and agent substance integration system according to various embodiments described herein.

FIG. 4—FIG. 4 depicts a perspective view of an example of a foodstuff and agent substance integration agitation device according to various embodiments described herein.

FIG. 5—FIG. 5 illustrates a perspective view of an example of an agent permeated foodstuff according to various embodiments described herein.

FIG. 6—FIG. 6 shows a sectional, through line 6-6 shown in FIG. 5, elevation view of an example of an agent permeated foodstuff according to various embodiments described herein.

FIG. 7—FIG. 7 shows an example of a foodstuff and agent substance integration method according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

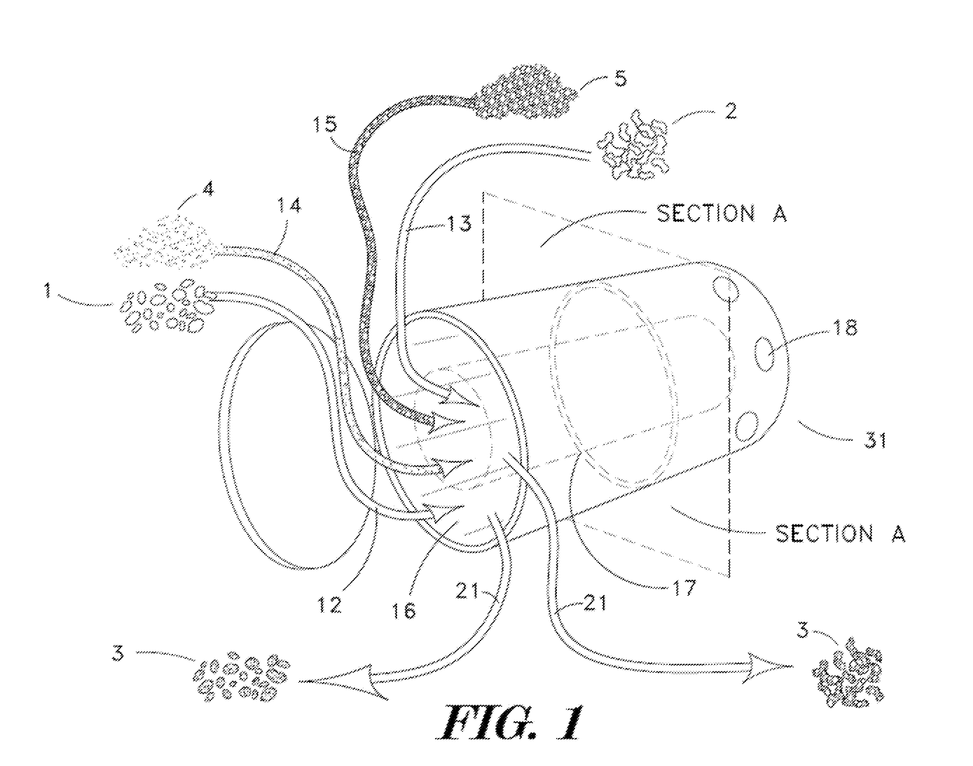

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

New systems and methods that facilitate the integration of one or more agent substances, such as for flavor, nutrition, medication, or the like, into the structures of dry foodstuffs are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

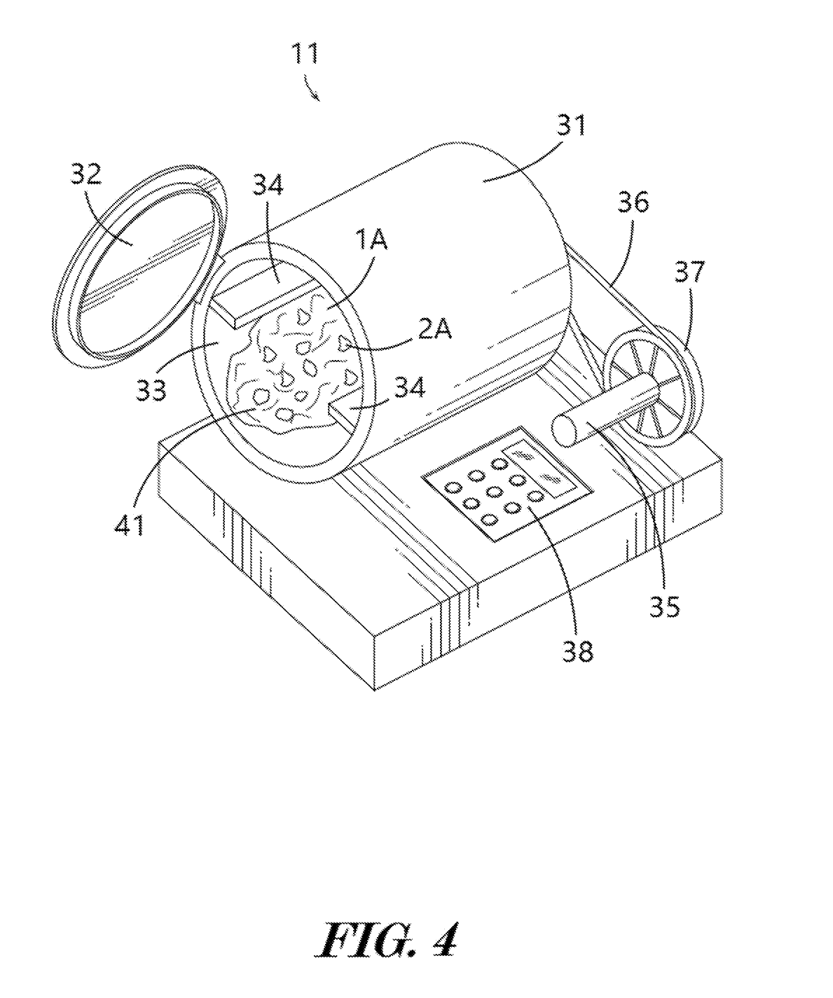

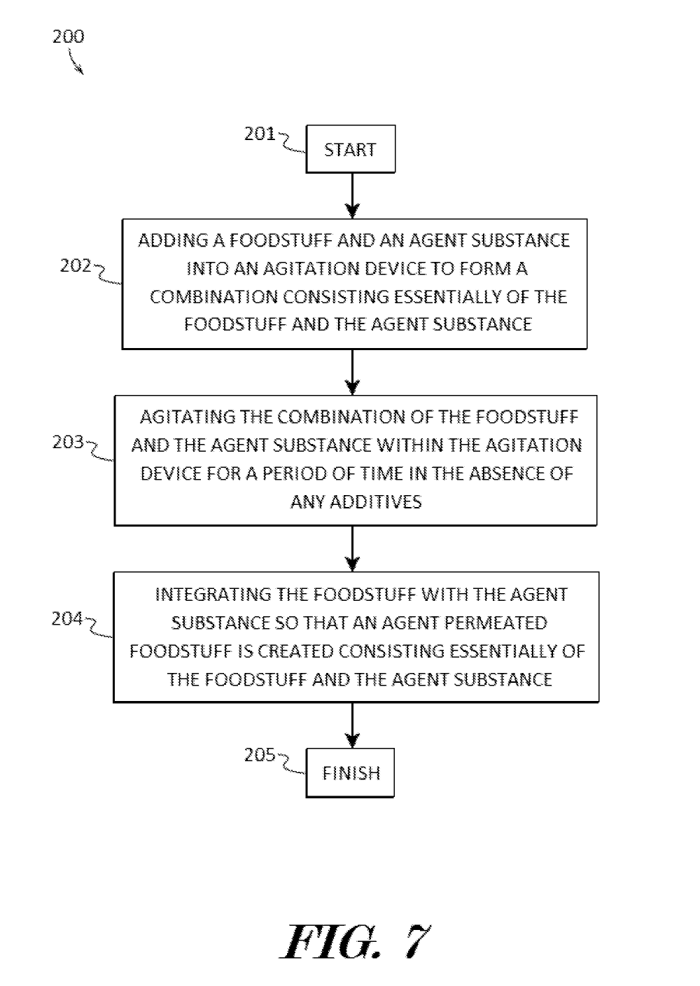

The present invention will now be described by example and through referencing the appended figures representing preferred and alternative embodiments. Now with reference primarily to FIG. 1, embodiments of the inventive technology may involve a system 100 and method 200 (FIG. 7) for creating an agent permeated foodstuff (3) with an agitation device (11) (FIG. 4). The method 200 may involve providing a substantially dry agent substance (1).

Agent substances (1) in various embodiments may include substances having a flavor property or otherwise tending to impart flavor. Examples may include coffee, chocolate, cinnamon, mocha, black pepper, capsaicin containing pepper, or the like, but naturally may include any substance consistent with the inventive principles discussed herein, and any combination of any such individual flavors consistent with the inventive principles discussed herein. In further embodiments, an agent substance may be a spice which may be a seed, fruit, root, bark, berry, bud or other vegetable substance primarily used for flavoring, coloring or preserving food. Examples may include: dried fruits or seeds, such as fennel, mustard, nutmeg, and black pepper; arils, such as mace (part of nutmeg plant); barks, such as cinnamon and cassia; dried flower buds, such as cloves; stigmas, such as saffron; roots and rhizomes, such as turmeric, ginger and galingale; and resins, such as asafetida. Further examples may include: Advieh; Baharat; Berbere; Bumbu; Chaat masala; Cajun seasoning; Chili powder; Curry powder; Five-spice powder; Garam masala; Harissa; Hawaij; Jerk spice; Khmeli suneli; Masala; Mixed spice; Old Bay Seasoning; Panch phoron; Pumpkin pie spice; Quatre epices; Ras el hanout; Shichimi togarashi; Vegeta; Za'atar; Sharena sol; summer savory; paprika; fenugreek; and salt.

In further embodiments, agent substances (1) may include substances having a medicinal property or otherwise tending to exert an effect on an animal body, such as a human, when ingested. Examples may include powdered alcohol, caffeine, cannabis, cannabidiol (CBD) any other cannabinoid, antibiotics, antimicrobials, vaccines, pain medicines, blood pressure medicines, other medical drugs, or the like, but naturally may include any substance consistent with the inventive principles discussed herein, and any combination of any such individual medicinal consistent with the inventive principles discussed herein.

In further embodiments, agent substances (1) may include substances having a nutritional property or otherwise tending to provide nutrition or a nutrient to an animal body, such as a human, when ingested. Examples may include protein powder, curcumin, black bean or other bean powder, fish oil, probiotics, carrot powder, garlic powder, powdered lemon, powdered orange, powdered lime, powdered grape fruit, other powder citrus, vitamins, such as Vitamin A, B Vitamins, Vitamin C, Vitamin D, Vitamin E, and the like, minerals, such as zinc, selenium, iron, and the like, herbs, such as Echinacea, Ginseng, Feverfew, Khava khava, and the like, but naturally may include any substance consistent with the inventive principles discussed herein, and any combination of any such individual vitamins, minerals, and/or herbals consistent with the inventive principles discussed herein.

It also should be understood that agents substances (1) simply may be a subset of agents generally, and any agent capable of imparting a property to a foodstuff may be used as consistent with the inventive principles discussed herein, such as nutrition agents, medication agents, and the like. In some embodiments, for example, an agent may be a caffeine agent, or even a caffeine flavor agent.

Substantially dry agent substances (1) may comprise agent substances (1) that are free or substantially free from moisture or a liquid. In various embodiments, a substantially dry agent substance (1) may have a moisture content of less than 20%, less than 10%, less than 5%, less than 2%, and including 0.5% or less moisture. In some embodiments, an agent substance (1) may be in a formulation such as a powdered agent substance, a granulated agent substance, and a freeze dried agent substance such as freeze dried coffee, or the like.

In some embodiments, a substantially dry agent substance (1) may be provided in a solids form, as in for example a powdered flavor agent, a granulated flavor agent, or the like. Where a substantially dry agent substance (1) is a substantially dry coffee flavor agent (1A), for example, embodiments may involve providing a powdered coffee flavor agent, a granulated coffee flavor agent, or perhaps providing instant coffee. Naturally, an agitation device (11) may include a substantially dry flavor agent input (12), which of course may be configured to input a substantially dry agent substance (1) having any of the flavors or other properties or characteristics as described herein. In preferred embodiments, an agent substance (1) may be in a powdered or granulized form having a particle size of 0.5 millimeters or less. In other embodiments, an agent substance (1) may be in a powdered or granulized form having a particle size of 1.5 millimeters or less. For example, a powdered agent substance (1) may include cocoa powder, coffee powder, tea powder, caffeine powder, pepper powder, cinnamon powder, powdered Vitamin B, powdered Iron, powdered cannabis, etc.

The method 200 also may involve providing a foodstuff (2). Such a foodstuff (2) may be capable of being used as a nutriment and may have a structure susceptible, by permeation or the like, to receiving and holding a substantially dry agent substance (1), such as by spaces, pores, interstices, or the like formed within such structure. Moreover, the foodstuff (2) may be substantially dry, such as in the manner described for dry flavor agents, or perhaps as may be typical for various kinds of dried fruits. In some embodiments, a substantially dry foodstuff (2) may comprise a moisture content of between 1% and 85%. In further embodiments, a substantially dry foodstuff (2) may comprise a moisture content of between 5% and 50%. In still further embodiments, a substantially dry foodstuff (2) may comprise a moisture content of between 13% and 18%. Indeed, a substantially dry foodstuff (2) in various embodiments may include dried fruits, such as raisins, apricots, cherries, pomegranates, cranberries, persimmons, plums, strawberries, pears, currants, nectarines, pineapples, peaches, mangos, kiwis, dates, apples, figs, prunes, papayas, or any combination thereof, and the like. In further embodiments, a foodstuff (2) may include meat, such as dried beef or jerky, dried chicken or jerky, dried pork or jerky, dried fish or jerky, any other type of dried meat, macaroni, any other dried pasta or dried food, potatoes, sweet potatoes, spinach, kale, taro, green beans, other beans and legumes, cucumbers, carrots, squash, corn, beets, radishes, other vegetables, and the like, but naturally may include any substance consistent with the inventive principles discussed herein, and any combination of any such individual foodstuff (2) consistent with the inventive principles discussed herein. Of course, an agitation device 11 may include a substantially dry foodstuff input (13), which of course may be configured to input a substantially dry foodstuff (2) of the kinds or having any of the other properties or characteristics as described herein.

With respect to the steps of providing a substantially dry agent substance (1) and a substantially dry foodstuff (2), of course it should be understood that multiple agent substances and multiple foodstuffs may be utilized, either separately or in any combinations or amounts consistent with the inventive principles described herein. As but one example, embodiments may involve providing at least one additional substantially dry agent substance (4), at least one additional substantially dry foodstuff (5), or both at least one additional substantially dry agent substance (4) and at least one additional substantially dry foodstuff (5). An agitation device (11) accordingly may have in various embodiments at least one additional substantially dry agent substance input (14) and/or at least one additional dry permeable foodstuff input (15).

As perhaps best shown in FIGS. 1-4, in some embodiments, the method 200 may comprise agitating a combination of a foodstuff (2) and an agent substance (1) within an agitation device (11). An agitation device (11) may comprise an agitation chamber (31), and an optional lid (32), which may form a cavity (33). The cavity (33) may bound and form a substantially liquid-free agitation area (16) and/or a substantially liquid-free permeation zone (17). By depositing or adding one or more foodstuffs (2) into contact with one or more agent substances (1), a combination consisting essentially of one or more foodstuffs and one or more agent substances (41) may be formed. In some embodiments, by depositing or adding a foodstuff (2) and an agent substance (1) into contact with each other within the cavity (33) of an agitation device 11, a combination consisting essentially of one or more foodstuffs and one or more agent substances (41) may be formed in step 202.

In some embodiments, an agitation device (11) may comprise a food tumbler type of agitation device (11) which may be configured with a cavity (33) comprising one or more paddles (34). A paddle (34) may comprise a projection of any size or shape which may optionally be coupled to the agitation chamber (31) and/or optionally movably positioned within the cavity (33). In preferred embodiments, an agitation device (11) may comprise a motor (35) which may be coupled to the agitation chamber (31) such as with a belt (36) and pulleys (37), gears, chain drive, drive shaft, or any other suitable method of motion transfer including direct coupling of a motor (35) to the agitation chamber (31). In further embodiments, an agitation device (11) may comprise a control unit 38 which may function as a timer and control the agitation rate and time period.

In further embodiments, an agitation device (11) may be configured to perform rotational agitation so that a combination consisting essentially of one or more foodstuffs and one or more agent substances (41) within the cavity (33) may be rotated or tumbled by the rotation of the agitation chamber (31). In other embodiments, an agitation device (11) may be configured to perform vibrational agitation so that a combination consisting essentially of one or more foodstuffs and one or more agent substances (41) within the cavity (33) may be vibrated by the vibration of the agitation chamber (31). In still other embodiments, an agitation device (11) may be configured to perform stirring, blending, incorporating or any other type of agitation to combination consisting essentially of one or more foodstuffs and one or more agent substances (41) within the cavity (33).

The method 200 may involve agitating a substantially dry agent substance (1) and a substantially dry foodstuff (2) in the substantial absence of a liquid that is not intrinsic to the substantially dry agent substance (1) and a substantially dry foodstuff (2). In such agitation, a liquid may not be the medium of permeation of a substantially dry foodstuff (2) with a substantially dry agent substance (1), or otherwise may not play an outcome determinative role in such permeation, infusion, or the like. For example, agitation may occur in the substantial absence of liquids typically involved in foodstuff preparation, such as water, syrups, fruit juices, or the like, or perhaps simply may be restricted to the residual moisture, if any, of a dried fruit provided as the substantially dry foodstuff (2). Of course, embodiments may include the complete absence of moisture, liquids, or the like which are not intrinsic to the agent substance (1) or foodstuff (2) during such agitation, or perhaps may be limited to such as may be contributed by a substantially dry agent substance (1) or a substantially dry foodstuff (2).

An agitation device 11 accordingly may have in various embodiments a substantially liquid-free agitation area (16) configured to receive a substantially dry agent substance (1) from a substantially dry agent substance input (14) and a substantially dry foodstuff (2) from a substantially dry permeable foodstuff input (15). Naturally, the substantially liquid-free agitation area (16) may have any of the properties or characteristics described herein.

The method 200 may involve permeating a substantially dry foodstuff (2) with a substantially dry agent substance (1) as a result of agitating them. For example, the relative motions of the foodstuff and the agent substance during agitation may create multiple opportunities for contact, wherein the agent substance (1), through such contact, may permeate the foodstuff (2), as may be encouraged by the motions of the agitation. As mentioned above, the foodstuff (2) may have spaces, pores, interstices, or the like, capable of receiving and holding the agent substance (1) through such permeation or integration. Where the agent substance (1) is in a solids form, such as powder or granules, permeation may be effected by allowing individual grains to permeate through such spaces, pores, interstices, or the like. In this manner, the agent substance (1) and the foodstuff (2) may be integrated together to form an agent permeated foodstuff (3) in which the agent substance (1) and the foodstuff (2) may not be separated by physical or mechanical methods. This integration is distinct from a foodstuff that is coated with a cereal or flavoring agent since the coating of the cereal or flavoring agent may be broken off, washed off, or otherwise removed from the foodstuff.

An apparatus accordingly may have a substantially liquid-free permeation zone (17) of a substantially liquid-free agitation area (16) responsive to a substantially dry agent substance input (14) and a substantially dry permeable foodstuff input (15). Moreover, various embodiments may involve permeating in the absence of applied heat, perhaps such as approximately room temperature. Permeating also may be done in the absence of an applied vacuum, or perhaps by applying only a low-pressure vacuum during the step of permeating, such as up to 25 inches of mercury.

Naturally, the substantially liquid-free permeation zone (17) may have any of the properties or characteristics described herein, including without limitation being an unheated permeation zone, a permeation zone at approximately room temperature, or a no-vacuum permeation zone, and in embodiments may further comprise a low-pressure vacuum applicator to which the permeation zone is responsive. In some embodiments, applying a low pressure vacuum may involve applying up to 25 inches of mercury, and a low-pressure vacuum applicator may be an up to 25 inches of mercury low-pressure vacuum applicator.

Permeating may comprise the step of integrating the substantially dry permeable foodstuff (2) with the substantially dry agent substance (1). The substantially dry agent substance (1), as a result of integration, may be distributed or permeated through the body of the foodstuff (2) in whole or in part, such as to be infused or embedded into the body of the foodstuff, as opposed to merely coating the surface of the foodstuff (2) with the agent substance (1). In this manner, an agent permeated foodstuff (3) may be formed or created. In some embodiments, the agent permeated foodstuff (3) may be a rinse-proof agent permeated foodstuff (3), in as much as the agent substance (1) may not be able to be simply rinsed off of a surface of the agent permeated foodstuff (3).

The method 200 may result in creating an agent permeated foodstuff (3) from the substantially dry agent substance (1) and the substantially dry foodstuff (2). In some embodiments, the method 200 may include integrating the foodstuff with one or more agent substances so that an agent permeated foodstuff is created consisting essentially of the foodstuff and the one or more agent substances as step 204. Integration may follow from the steps of agitating and permeating, such as wherein the agent (1) may be held within the permeable structure of the foodstuff (2), so as perhaps to become integrated with the foodstuff and impart its flavor, medicinal, or other characteristics to the agent permeated foodstuff (3). Accordingly, an agitation device (11) may have an agent permeated foodstuff output (21) responsive to the substantially liquid-free agitation area (16).

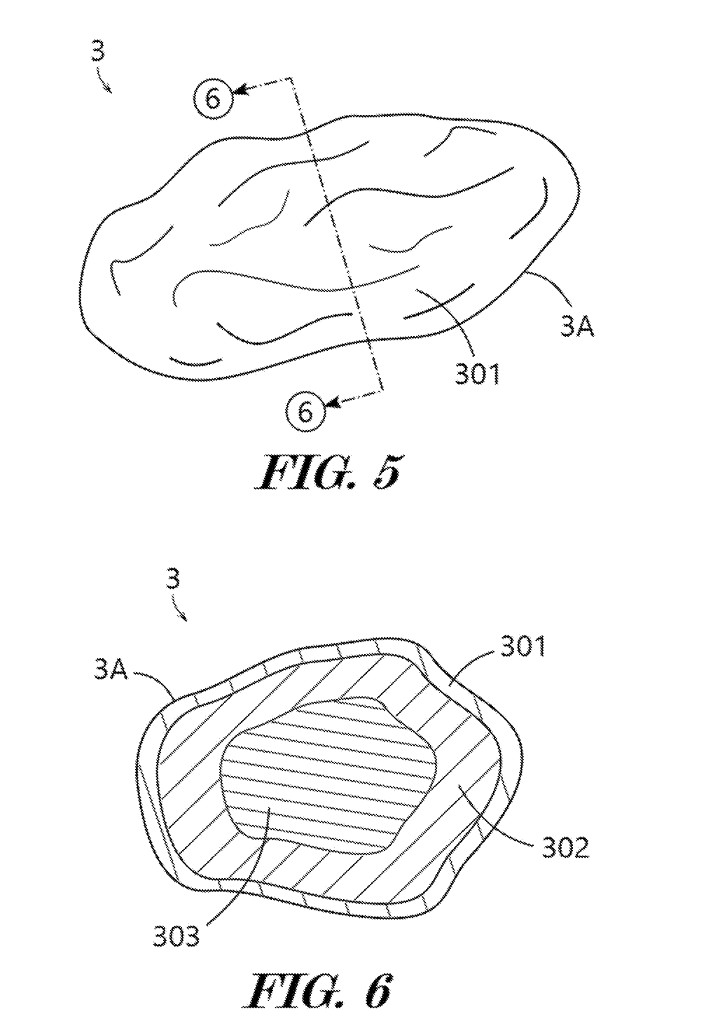

As perhaps best shown in FIGS. 5 and 6, an exemplary agent permeated foodstuff (3) is illustrated. In this example, the agent permeated foodstuff (3) is a coffee agent permeated raisin foodstuff (3A). The coffee flavor agent permeated raisin foodstuff (3A) may be formed according to the foodstuff and agent substance integration method 200 shown in FIG. 7. In some embodiments, the method 200 may begin 201 and a foodstuff (2), such as a raisin foodstuff (2A), and one or more agent substances (1), such as a coffee agent substance (1A), ground cinnamon powder, etc. , may be added into an agitation device (11) to form a combination consisting essentially of the foodstuff and the one or more agent substances (41) in step 202. Next in step 203, the combination of the foodstuff and the one or more agent substances (41) may be agitated within the agitation device (11) for a period of time in the absence of any additives. Finally in step 204, the foodstuff may be integrated with the one or more agent substances so that an agent permeated foodstuff (3), such as a coffee agent permeated raisin foodstuff (3A), may be created consisting essentially of the foodstuff (2) and the one or more agent substances (1).

As shown in FIGS. 5 and 6, an agent permeated foodstuff (3) may be a coffee agent permeated raisin foodstuff (3A). In some embodiments, agitation of the coffee agent substance (1A) and raisin foodstuff (2A) for a period of time may result in a coffee agent permeated raisin foodstuff (3A) having coffee agent substance (1A) integrated into the outer skin or exterior surface (301) of the permeated raisin foodstuff (3A). In further embodiments, agitation of the coffee agent substance (1A) and raisin foodstuff (2A) for a period of time may result in a coffee agent permeated raisin foodstuff (3A) having coffee agent substance (1A) integrated into the outer skin or exterior surface (301) and the sub surface (302) of the permeated raisin foodstuff (3A). In still further embodiments, agitation of the coffee agent substance (1A) and raisin foodstuff (2A) for a period of time may result in a coffee agent permeated raisin foodstuff (3A) having coffee agent substance (1A) integrated into the outer skin or exterior surface (301), the sub surface (302), and the central or interior portions (303) of the permeated raisin foodstuff (3A). A relatively shorter agitation period may result in a coffee agent permeated raisin foodstuff (3A) having coffee agent substance (1A) integrated into the outer skin or exterior surface (301), while a relatively longer agitation period may result in a coffee agent permeated raisin foodstuff (3A) having coffee agent substance (1A) integrated into the outer skin or exterior surface (301) and the sub surface (302) and the central or interior portions (303) of the permeated raisin foodstuff (3A).

In various embodiments, integration may involve highly permeating a substantially dry foodstuff (2) with a substantially dry agent substance (1) so that in addition to an agent permeated foodstuff (3) having an agent substance (1) integrated into the outer skin or exterior surface (301), the agent permeated foodstuff (3) may also have an agent substance (1) integrated the sub surface (302) and/or the central or interior portions (303) of the agent permeated foodstuff (3). The integration process may be effected with a high degree of efficacy, such as perhaps wherein all or substantially all of the agent permeated foodstuff (3) is infused with agent (1), or perhaps wherein the agent permeated foodstuff (3) is permeated to its maximum or near-maximum possible degree of permeation with the agent (1). In embodiments wherein the foodstuff (3) is a dried fruit, high integration of an agent (1) into the dried fruit agent permeated foodstuff (3) may involve at least 98 percent integration of the dried fruit, at least 99 percent integration of the dried fruit, and at least 100 percent integration of the dried fruit. High integration in embodiments using dried fruit also may involve perhaps using up all or substantially all of a substantially dry agent (1) in the infusion process, for example so that there perhaps may be no or substantially no agent (1) left over.

Accordingly, a substantially liquid-free permeation zone (17) in various embodiments may be an integration zone having any of the integration properties and characteristics described herein, including but not limited to being a foodstuff sub-surface agent integration zone, a foodstuff rinse-proof agent integration zone, a high integration zone, an at least 98 percent dried fruit integration zone, an at least 99 percent dried fruit integration zone, a 100 percent dried fruit integration zone, a dried fruit maximum possible integration degree zone, a dried fruit near maximum possible integration degree zone, and the like. Naturally, an integration zone may have an integration temperature specification and an integration pressure specification consistent with the inventive principles discussed herein.

In some embodiments, agitating may comprise tumbling or rotational agitating a substantially dry foodstuff (2) with a substantially dry agent substance (1). Any suitable method of tumbling may be used consistent with the inventive principles described herein, and in various embodiments a substantially liquid-free agitation area (16) may be a tumbler type of agitation device (11), including but not limited to a suitable commercial tumbler, and including but not limited to tumblers having a tumbler capacity of up to 25 pounds, up to 50 pounds, up to 75 pounds, up to 100 pounds, up to 500 pounds, up to 1000 pounds, up to 2000 pounds, up to 3000 pounds, and the like.

The method 200 may include agitating a combination of a foodstuff (2) and one or more agent substances (1) within an agitation device (11) for a period of time preferably in the absence of any additives in step 203. In further embodiments, the foodstuff (2) and agent substance (1) may be agitated in the device (11) for a period of time in the absence of any additives including lipids, waxes, oils, food polymers, aqueous solutions, water, cereal, fructan, plasticizer, gum, fruit juice, syrups, and polymeric coatings which are typically used to adhere, affix, or otherwise coat flavors, cereals, and the like to foodstuff

In some embodiments, the period of agitating time may be approximately 30 minutes to 48 hours. In preferred embodiments, the period of time may be approximately at least one hour. In further embodiments, the period of time may be approximately one hour to twelve hours. In still further embodiments, the period of time may be approximately 10 minutes to 36 hours. Some embodiments may involve long tumbling, such as perhaps for a duration longer than typically commercially employed when tumbling the relevant kinds of foodstuffs and agents. In some embodiments, long tumbling may involve tumbling for at least 9 hours, at least 12 hours, at least 15 hours, or perhaps even longer. Moreover, any suitable tumbling rate may be utilized consistent with the inventive principles described herein, including perhaps tumbling at a generally moderate rate, or perhaps in various embodiments from one or more revolutions of an agitation chamber (31) per minute or perhaps from 1 percent to 100 percent of a maximum rate of a tumbler. Accordingly, a tumbler in various embodiments may include a long-duration tumbler, an at least 9-hour tumbler, an at least 12-hour tumbler, an at least 15-hour tumbler, and tumblers having an appropriate rate specification and operational duration specification and the like.

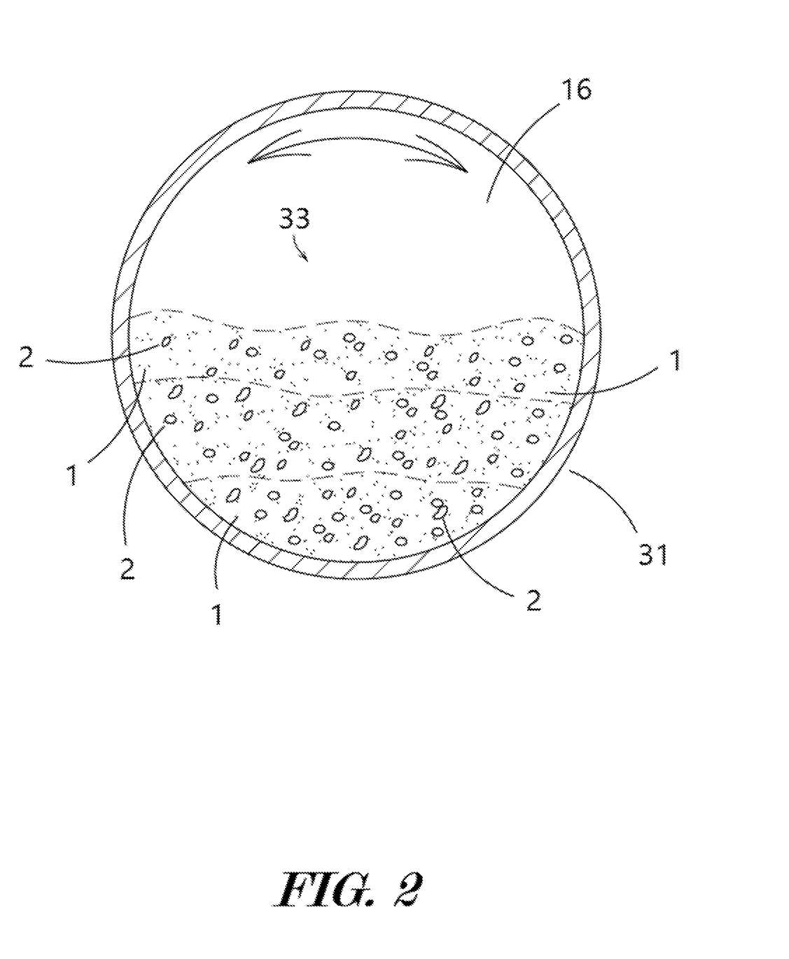

Now with reference primarily to FIG. 2, embodiments also may involve tumbling at a limited tumbler capacity, as wherein a tumbler type agitation device (11) may not be filled to its capacity with the relevant foodstuff and flavor agent to be tumbled, and indeed perhaps may be filled to substantially less than its capacity. Any suitable total tumbler type agitation device (11) capacity may be utilized consistent with the inventive principles described herein, and tumbling in various embodiments may involve, for example, tumbling with a tumbler type agitation device (11) having a capacity of up to 25 pounds, tumbling with a tumbler type agitation device (11) having a capacity of up to 50 pounds, tumbling with a tumbler type agitation device (11) having a capacity of up to 75 pounds, tumbling with a tumbler type agitation device (11) having a capacity of up to 100 pounds, and the like. Tumbling at a limited tumbler capacity in various embodiments may involve, for example, tumbling at up to 30 percent of a tumbler type agitation device (11) capacity, tumbling at up to 40 percent of a tumbler type agitation device (11) capacity, tumbling at up to 50 percent of tumbler type agitation device (11) capacity, and the like. However, any limited tumbler capacity capable of effecting the inventive principles discussed below may be utilized consistent with the inventive principles discussed herein.

Accordingly, a tumbler type agitation device (11) in various embodiments may be a low-load tumbler type agitation device (11), which may involve tumblers with a low-load capacity up to 30 percent tumbler capacity load, tumblers with a low-load capacity up to 40 percent tumbler capacity load, tumblers with a low-load capacity up to 50 percent tumbler capacity load, and the like.

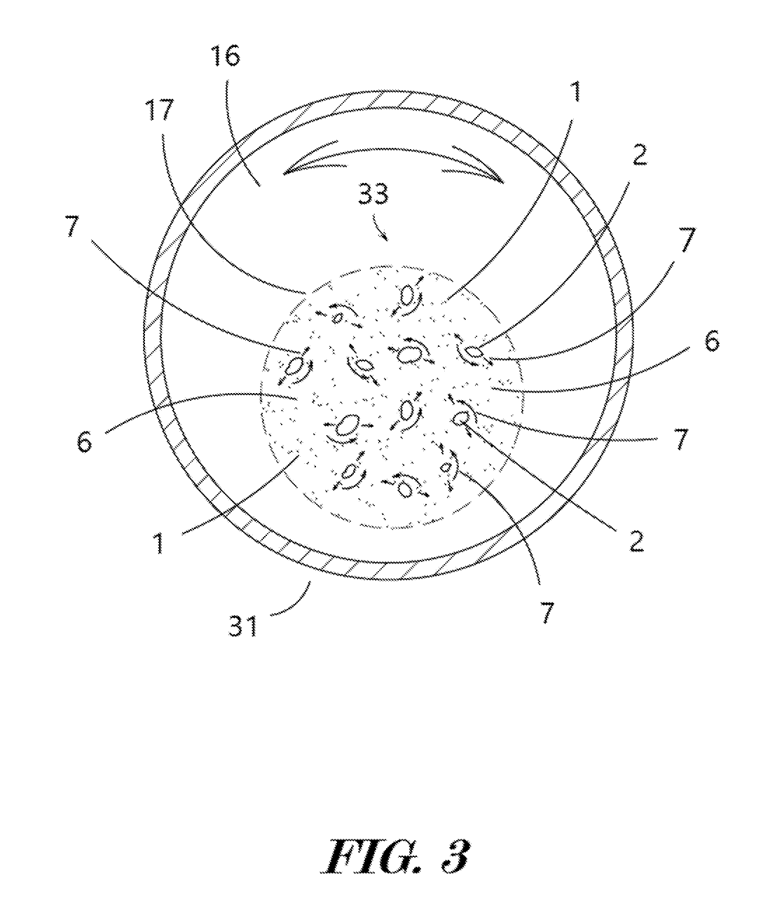

Now with reference primarily to FIG. 3, tumbling at a limited tumbler capacity in various embodiments may have the effect of expanding tumbling space for a substantially dry agent substance (1) and a substantially dry foodstuff (2). Unlike a tumbler type agitation device (11) filled with a foodstuff and agent substance to capacity, near capacity, or even simply a substantial capacity, an expanded tumbling space of a tumbler type agitation device (11) filled to a limited tumbler capacity may allow the foodstuff and agent substance more space in which to agitate. Rather than being held back by the overall mass of the foodstuff and agent substance, as may be the case with conventionally filled tumbler type agitation device (11), the expanded tumbling space of a limited capacity tumbler type agitation device (11) may allow both the foodstuff (2) and the agent (1) greater freedoms of motion, such as the ability to translate more freely, rotate more freely, and the like. This may increase the degree, intensity, or the like of the agitation, perhaps increasing the effectiveness of the permeation of the foodstuff (2) with the agent (1). Accordingly, a low-load tumbler type agitation device (11) may have an expanded tumble space (6) having any of the expanded tumbling space properties and characteristics described herein, and which of course may response to a substantially dry agent substance input (12) and a substantially dry permeable foodstuff input (13).

Tumbling at a limited tumbler capacity in various embodiments also may have the effect of increasing tumbling contact for a substantially dry agent substance (1) and a substantially dry foodstuff (2). It may be appreciated that contact between the agent and foodstuff may be a prerequisite for integrating the foodstuff with the agent substance. It may follow that the greater the degree of contact, the greater the opportunity for inegration, and perhaps the greater the effectiveness of creating an agent permeated foodstuff (3). Tumbling at a limited tumbler capacity may promote increased tumbling contact, such as perhaps by reducing restrictions on the movement of tumbled foodstuffs and agents and promoting their ability to interact with one another. Accordingly, a low-load tumbler type agitation device (11) may have an increased tumble contact range (7) having any of the increased tumbling contact properties and characteristics described herein, and which of course may response to a substantially dry agent input (12) and a substantially dry permeable foodstuff input (13).

Tumbling at a limited tumbler capacity in various embodiments additionally may have the effect of promoting substantially clumpless tumbling. Unlike conventional processes, wherein the end result of tumbling may result in clumping of created agent permeated foodstuff (3), tumbling at a limited tumbler capacity may reduce the opportunities for clumping to occur, such as by reducing the overall density of the tumbled foodstuffs and agents. This further may result in avoiding the need for post-tumbling declumping measures. Accordingly, a low-load tumbler type agitation device (11) may be in some embodiments a substantially clumpless tumbler having any of the clumpless tumbling properties and characteristics described herein, and which of course may have a post-tumbler declump-free egress.

Now with further attention to FIG. 1, in one exemplary embodiment, a method 200 for creating an agent permeated foodstuff (3) may involve providing a raisin-type foodstuff 2A, providing instant coffee agent substance (1A), tumbling approximately 20 pounds of the raisins (2A) in a tumbler type agitation device (11) having approximately a 50 pound tumbling capacity with the instant coffee agent substance (1A) at a moderate tumbling rate for at least 12 hours, infusing the raisins (2A) with the instant coffee at approximately room temperature in the absence of a vacuum, and creating coffee agent permeated raisin foodstuff (3A).

Now with reference primarily to FIG. 4, embodiments of the inventive technology may involve a method 200 for flavoring a foodstuff comprising the steps of providing a coffee agent substance (1A), providing a raisin foodstuff (2A), permeating at least some of the raisin foodstuff (2A) with the coffee agent substance (1A), infusing at least some of the raisin foodstuff (2A) with the coffee agent substance (1A) as a result of the step of permeating, and creating a coffee flavor agent permeated raisin foodstuff (3A) from the coffee agent substance (1A) and the raisin foodstuff (2A). The coffee agent substance (1A) in various embodiments may be instant coffee, and infusing the raisin foodstuff (2A) may involve infusing the coffee agent substance (1A) in the raisin foodstuff (2A) deeper than a surface coating of the raisin foodstuff (2A), rinse-proof infusing the coffee agent substance (1A) in the raisin foodstuff (2A), and highly infusing the raisin foodstuff (2A) with the coffee agent substance (1A).

Naturally, embodiments may include a flavored foodstuff comprising a raisin foodstuff (2A) having a permeable structure (20), a coffee agent substance (1A) infused into at least some of the permeable structure (20) of the raisin foodstuff (2A), and a coffee flavor of the raisin foodstuff (2A), which of course may follow from having the coffee agent substance (1A) infused therein. In various embodiments, the coffee agent substance (1A) may be instant coffee, a rinse-proof coffee flavor agent substance (1A), a coffee agent substance (1A) infused below the surface of the raisin foodstuff (2A), a coffee agent substance (1A) highly infused into at least some of the permeable structure of the raisin foodstuff (2A), or the like.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A foodstuff and agent substance integration method, the method comprising the steps of:
adding a foodstuff and one or more agent substances into an agitation device to form a combination consisting essentially of the foodstuff and the one or more agent substances;
agitating the combination of the foodstuff and the one or more agent substances within the agitation device for a period of time in the absence of any additives; and p1 integrating the foodstuff with the one or more agent substances so that an agent permeated foodstuff is created consisting essentially of the foodstuff and the one or more agent substances.

2. The method of claim 1, wherein the food stuff is a dried food selected from the group consisting essentially of raisins, apricots, cherries, pomegranates, cranberries, persimmons, plums, strawberries, pears, currants, nectarines, pineapples, peaches, mangos, kiwis, dates, apples, figs, prunes, papayas, dried beef, dried chicken, dried pork, macaroni, potatoes, beans, legumes, cucumbers, carrots, squash, corn, beets, and radishes.

3. The method of claim 1, wherein each agent substance is selected from the group consisting essentially of coffee, chocolate, cinnamon, mocha, black pepper, capsaicin containing pepper, fennel, mustard, nutmeg, black pepper, arils, cassia, cloves, saffron, turmeric, ginger, galingale, asafetida, Advieh, Baharat, Berbere, Bumbu, Chaat masala, Cajun seasoning, Chili powder, Curry powder, Five-spice powder, Garam masala, Harissa, Hawaij, Jerk spice, Khmeli suneli, Masala, Mixed spice, Old Bay Seasoning, Panch phoron, Pumpkin pie spice, Quatre epices, Ras el hanout, Shichimi togarashi, Vegeta, Za'atar, Sharena sol, summer savory, paprika, fenugreek, salt, alcohol, caffeine, cannabis, antibiotics, antimicrobials, vaccines, pain medicines, blood pressure medicines, Vitamin A, B Vitamins, Vitamin C, Vitamin D, Vitamin E, zinc, selenium, iron, Echinacea, Ginseng, Feverfew, and Khava khava.

4. The method of claim 1, wherein each agent substance is in a formulation selected from the group consisting of a powdered agent substance, a granulated agent substance, and a freeze dried agent substance.

5. The method of claim 1, wherein the additives are selected from the group consisting essentially of lipids, waxes, oils, food polymers, aqueous solutions, water, cereal, fructan, plasticizer, gum, fruit juice, syrups, and polymeric coatings.

6. The method of claim 1, wherein the food stuff has a moisture content of about 5% to about 50% by weight.

7. The method of claim 1, wherein the agitation is for a period of time of at least one hour.

8. The method of claim 1, wherein the agitation is performed in a food tumbler.

9. The method of claim 8, wherein the food tumbler performs rotational agitation.

10. The method of claim 8, wherein the food tumbler comprises paddles.

11. The method of claim 1, wherein the agent substance has a particle size of 0.5 millimeters or less.

12. A foodstuff and agent substance integration method, the method comprising the steps of:
adding a foodstuff and one or more agent substances into an agitation device to form a combination consisting essentially of the foodstuff and the one or more agent substances, wherein each agent substance has a particle size of 0.5 millimeters or less;
agitating the combination of the foodstuff and the one or more agent substances within the agitation device for a period of time in the absence of any additives; and
integrating the foodstuff with the one or more agent substances so that an agent permeated foodstuff is created consisting essentially of the foodstuff and the one or more agent substances.

13. The method of claim 12, wherein the wherein the food stuff is a dried food selected from the group consisting essentially of raisins, apricots, cherries, pomegranates, cranberries, persimmons, plums, strawberries, pears, currants, nectarines, pineapples, peaches, mangos, kiwis, dates, apples, figs, prunes, papayas, dried beef, dried chicken, dried pork, macaroni, potatoes, beans, legumes, cucumbers, carrots, squash, corn, beets, and radishes.

14. The method of claim 12, wherein each agent substance is selected from the group consisting essentially of coffee, chocolate, cinnamon, mocha, black pepper, capsaicin containing pepper, fennel, mustard, nutmeg, black pepper, arils, cassia, cloves, saffron, turmeric, ginger, galingale, asafetida, Advieh, Baharat, Berbere, Bumbu, Chaat masala, Cajun seasoning, Chili powder, Curry powder, Five-spice powder, Garam masala, Harissa, Hawaij, Jerk spice, Khmeli suneli, Masala, Mixed spice, Old Bay Seasoning, Panch phoron, Pumpkin pie spice, Quatre epices, Ras el hanout, Shichimi togarashi, Vegeta, Za'atar, Sharena sol, summer savory, paprika, fenugreek, salt, alcohol, caffeine, cannabis, antibiotics, antimicrobials, vaccines, pain medicines, blood pressure medicines, Vitamin A, B Vitamins, Vitamin C, Vitamin D, Vitamin E, zinc, selenium, iron, Echinacea, Ginseng, Feverfew, and Khava khava.

15. The method of claim 12, wherein each agent substance is in a formulation selected from the group consisting of a powdered agent substance, a granulated agent substance, and a freeze dried agent substance.

16. The method of claim 12, wherein the additives are selected from the group consisting essentially of lipids, waxes, oils, food polymers, aqueous solutions, water, cereal, fructan, plasticizer, gum, fruit juice, syrups, and polymeric coatings.

17. The method of claim 12, wherein the food stuff has a moisture content of about 5% to about 50% by weight.

18. The method of claim 12, wherein the agitation is for a period of time of at least one hour.

19. The method of claim 12, wherein the agitation is performed in a food tumbler.

20. The method of claim 19, wherein the food tumbler performs rotational agitation.
